(19) United States
(12) Patent Application Publication
(10) Pub. No.: US 2010/0271981 A1
(43) Pub. Date: Oct. 28, 2010

(54) METHOD AND SYSTEM F0R DATA STREAMING

(76) Inventors: Wei Zhao, Solna (SE); Johan Kölhi, Vaxholm (SE)

Correspondence Address: ERICSSON INC., 6300 LEGACY DRIVE, M/S EVR 1-C-11, PLANO, TX, 75024, US

(21) Appl. No.: 12/747,277

(22) PCT Filed: Dec. 10, 2007
(86) PCT No.: PCT/SE07/50969

§ 371 Date: Jun. 14, 2010

(51) Int. Cl. H04L 12/28

(52) U.S. Cl. 370/256

(57) ABSTRACT

The present invention is a hybrid of a centralized solution and totally distributed peer-to-peer solution. It uses the load distribution idea of the peer-to-peer world. By splitting the multicast stream into a number of segments and transferring them through different trees, it overcomes the unbalanced resource usage faced by traditional single tree multicasting, thus improves the bandwidth efficiency of the network system and performance of the multicast application. In other words, it introduces the high resource efficiency of a peer-to-peer system into a network provider domain.

### TECHNICAL FIELD

The present invention relates to the technical field of video streaming, multicast, unicast and other video distribution techniques. More specifically, the present invention is related to a method, a system and devices for enabling High-bandwidth multicast support on robust Ethernet access network with fast failover.

### BACKGROUND

Multicast offers the scalable point-to-multipoint content distribution over the network, which is very efficient for streaming applications where one or several senders can deliver information to tens of thousands of receivers. With the uprising of IPTV (Interactive Personalized Television) and other multimedia applications, multicast support becomes more vital for the success of operators to both attract new customers and new service providers.

Supporting multicast in large network is a complex process. Currently multicast can be supported by the following ways:
Application-level multicast: It is also known as end-system multicast. In this proposal, the participating hosts use their own resources to route and distribute multicast messages using only unicast network services. In other words, the network is not involved at all in the multicast support. This is a very attractive solution to applications like peer-to-peer systems. Reference [1] gives a detailed description of this approach.
IP multicast: IP (Internet Protocol) provides multicast support by means of a number of features:
   Allocated special multicast IP addresses (the so-called class D IP address) resulting in that all packets with a class D destination address will be treated as multicast packets;
   Map multicast IP addresses onto specific layer 2 addresses. In Ethernet case, a set of Ethernet MAC (Media Access Control) addresses has been reserved specifically (0100.5e00.0000-0100.537f.ffff) for this purpose. The mapping may not be one-to-one, the over-lapping issues are left to upper-layer (IP) protocols;
   A set of management protocols to handle multicast registration process, such as IGMP (Internet Group Management Protocol), see reference [2], and MLD (Multicast Listener Discovery), see reference [3]. Using IGMP or MLD, a user can choose to join or leave particular multicast groups by sending corresponding join or leave messages to his local router, and periodically updates his status to remain in the multicast groups;
   A set of routing protocols to route multicast IP packets to the correct groups of destinations, such as DVMRP (Distance Vector Multicast Routing Protocol), see reference [4], MOSPF (Multicast Extension to Open Shortest Path First), see reference [5], and PIM-SM (Protocol Independent Multicast Sparse Mode), see reference [6].

Many layer-2 protocols such as ATM (Asynchronous Transfer Mode) and FDDI (Fibre Distributed Data Interface) have specific mechanism to deliver multicast traffics. Ethernet technology with its broadcasting nature becomes very promising to offer good multicast support for a layer-2 access networks.

The both two abovementioned mechanisms have their limitations.

For application based multicast support, it is actually implying the multicast application is initiated and coordinated by end systems, which can be totally out of control of any network or service providers. This model can work well for some multicast applications such as peer to peer file sharing, etc, but for some streaming applications such as IPTV which is provided by service providers and needs to be charged based on usage, the model lacks necessary control over the multicast application itself. So it may not be suitable for multicast service deployment from network or service providers. Limitations of IP based multicast support can be categorized into two types: Internet domain limitations and local domain limitations. For Internet domain, IP multicast has not provided sufficient support for issues such as group management, AAA (Authorization, Authentication and Accounting), security, etc, see reference [7]. For local domain limitations, especially for tree-based multicast systems, the multicast load is carried by a small number of nodes in the network, see reference [1]. This may work well for applications that do not have a very high bandwidth demand, but for applications like IPTV or even HDTV in the future, this may pose a resource problem: the traffic load is not balanced among all network nodes, thus leading to resource waste on one hand and long delay for some applications due to resource shortage on the other hand.

### SUMMARY

One problem identified in the above described technical field is that the data traffic load is not distributed effectively over the available paths and nodes through a network. Data streams needing very high bandwidth capacity may be distributed to already highly loaded path while some nodes and corresponding paths are unused or very little loaded.

One object of the following invention is to suggest a way of distributing and transmitting data streams through an access network, wherein the data traffic load is balanced among all network nodes and paths.

One aspect of the present invention is a method for transmitting a data stream from a first node of a spanning tree structure network to a second node of said network, wherein the data information of the incoming data stream (M) is split into a number of data segments, wherein each data segment is a unique portion of the total amount of data information carried in the incoming original data stream during time periods tₚ. The next steps are to generate a number of data sub-streams by distributing said data segments to said data sub-streams, and to distribute the different data sub-streams to different spanning trees of the network and transmitting each sub-stream through its assigned spanning tree to the second node. When receiving all sub-streams in the second node, the data segments are re-assembled from the received sub-streams to regenerate the original data stream.

Another aspect of the present invention is a Service Agent (SA) system for transmitting a data stream from a first node of a spanning tree structure network to a second node of said network, said nodes having at least one external connection outside the network. The system comprises a transmitting system block situated in the first node and comprising splitting means for splitting data information of the incoming data stream into a number of data segments, wherein each data segment is a unique portion of the total amount of data information carried in the incoming original data stream during time periods tₚ. The block further comprises means for generating a number of data sub-streams by distributing said data segments to said data sub-streams, wherein the means for generating data sub-streams is electrically connected to means for distributing the different data sub-streams to different spanning trees of the network. Said means is connected to a transmitter interface to transmit each sub-stream through its assigned spanning tree to a receiving system block situated in the second node. Said receiving block system comprises receiving means for receiving all incoming data sub-streams, and for forwarding said sub-streams to means for re-assembling the data segments from the received sub-streams to regenerate the original data stream.

Further one aspect of the present invention is a transmitting device which is identical to the transmitting system block of the above presented Service Agent (SA) system for transmitting a data stream from a first node of a spanning tree structure network to a second node of said network.

Moreover, further one aspect of the present invention is a receiving device, which is identical to the receiving block system of the above presented Service Agent (SA) system. Said receiving device comprises means for receiving a data stream transmitted from a first node of a spanning tree structure.

Different embodiments of the present invention are defined in the appended claims and in the detailed description section hereafter.

One advantage by splitting the data stream into a number of segments and transferring them through different trees is that it overcomes the unbalanced resource usage faced by traditional single tree multicasting, thus improves the bandwidth efficiency of the network system and performance of the multicast application. In other words, it introduces the high resource efficiency of a peer-to-peer system into a network provider domain.

Different embodiments of the present invention will now be described and discussed in more detail hereinafter with reference to the submitted drawings.

### BRIEF DESCRIPTION OF THE DRAWINGS

FIG. 1 is a block diagram showing a view over a physical network;

FIG. 2 is a block diagram showing a view over a network logically configured into a set of spanning trees;

FIG. 3 is a block diagram showing the network in FIG. 2 adapted to multicasting in accordance with the present invention;

FIG. 4 is a block diagram showing a flow-chart of the method in accordance with the present invention;

FIG. 5 is a block diagram showing an embodiment of the system according to present invention;

FIG. 6 is a block diagram showing another embodiment of the system according to present invention.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced and other embodiments that depart from these specific details. In other instances, detailed descriptions of well known methods, devices, and circuits are omitted so as not to obscure the description of the present invention with unnecessary detail.

This invention further extends the architectural advantage of what is known from reference [9] and applies it to a new area: the multicast.

In FIG. 1 is shown an example of a simple Ethernet network NW1. In the network four switching nodes SW1, SW2, SW3 and SW4 are shown and also four edge nodes EN1, EN2, EN3 and EN4 are shown. The nodes are all interconnected by links L. The network NW1 shown in FIG. 1 is just a simplified example network for illustration. Naturally, the present invention can be applied in wide networks having several internal nodes and edge nodes. The edge nodes are the nodes on the edge of network, which nodes may be configured to connect to other networks. The network NW1 has further nodes which are not shown in the figure. Three user, or subscriber, devices 150, 152, 158 are connected to EN2. To edge node EN3 are four devices 162, 164, 166, 168 connected, and finally, to EN4 are two devices 170, 172. However, the number of user devices is not limited by the illustrated embodiment. On the contrary, the number of user devices connected to each of the edge nodes is a designing option for an operator of NW1.

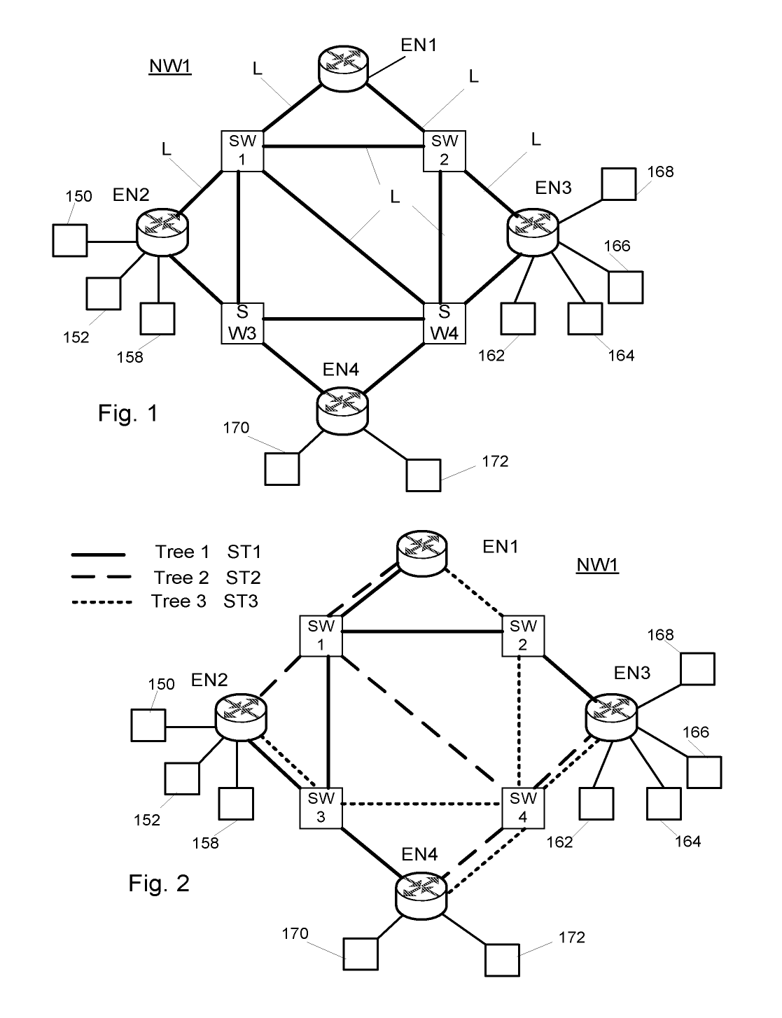

As illustrated in FIG. 2, three spanning trees are defined in the example network NW1, a first spanning tree ST1 shown in continuous lines between the nodes, a second spanning tree ST2 in dashed lines and a third spanning tree ST3 in dotted lines. To each of the spanning trees ST1, ST2, ST3 is assigned a Virtual Local Area Network VLAN1, VLAN2 and VLAN3 respectively. The network NW1 has the task to transport frames, exemplified by frames of a traffic message M1.

A method for configuration of spanning trees in networks is proposed in reference [9], which method can be applied in e.g. Ethernet segments consisting of standard Ethernet switches available on the market. The extra functionalities that are needed for providing resiliency can be implemented in edge nodes of the Ethernet network, which are typically IP routers. VLAN is assigned to each spanning tree, so traffic forwarding to a tree can be controlled with the help of VLAN IDs in the edge nodes. That is, in this example protection switching becomes VLAN switching in this network.

After configuring spanning trees ST1, ST2 and ST3 by the proposed method, failure detection and traffic redirection, which are the so-called additional functionalities, can be invoked in edge nodes.

The proposed method for the generation of static spanning trees determines a small number of spanning trees to solve fault handling. These trees have to be determined before the configuration of the network, so the proposed method is run off-line.

The construction of spanning trees is split up into two phases according to the two types of failures aimed to be handled. The first phase determines the spanning trees needed to protect against single link failures. The second phase determines the additional spanning trees needed for protecting against node failures after having the spanning trees for link failure. Each spanning tree for handling link failure connects all the nodes of a network.

The method generates spanning trees for a network and at least one of the spanning trees remains complete in case of the breakdown of any single network element. For this reason, the requirements for the spanning trees can be formulated in the following way for the two types of failures:
Link failure: For each link, there has to be at lest one spanning tree that does not include that particular link.
Node failure: For each node, that transports traffic there has to be at lest one spanning tree where that particular node is a leaf, i.e. that node is connected to its spanning tree via a single link.

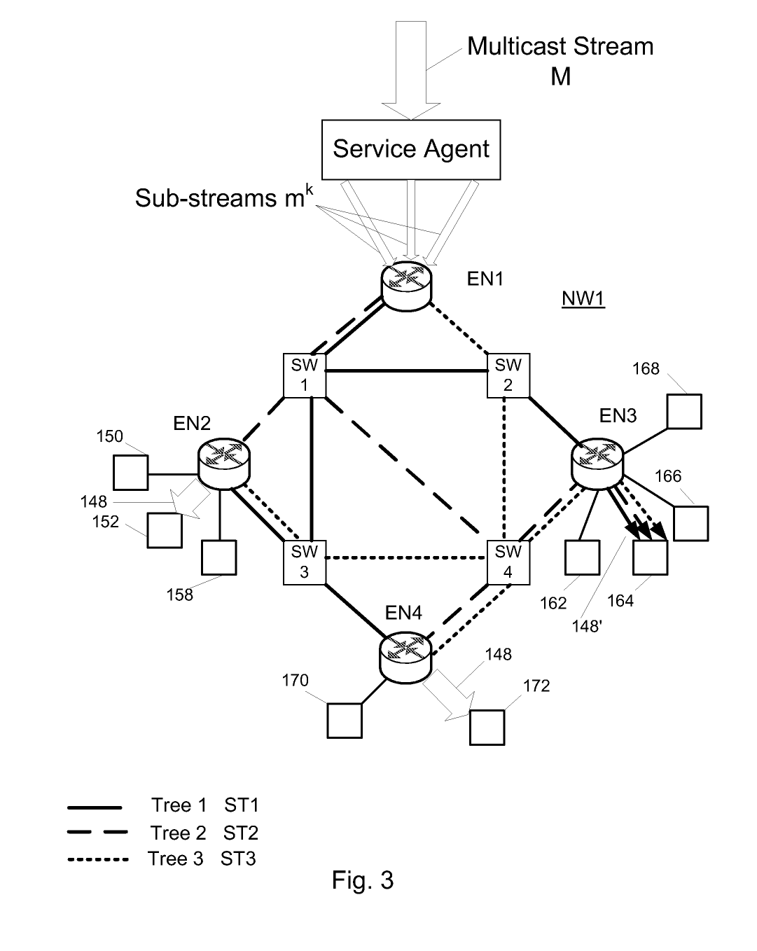

FIG. 3 shows the network in FIG. 2 adapted to multicasting in accordance with the present invention.

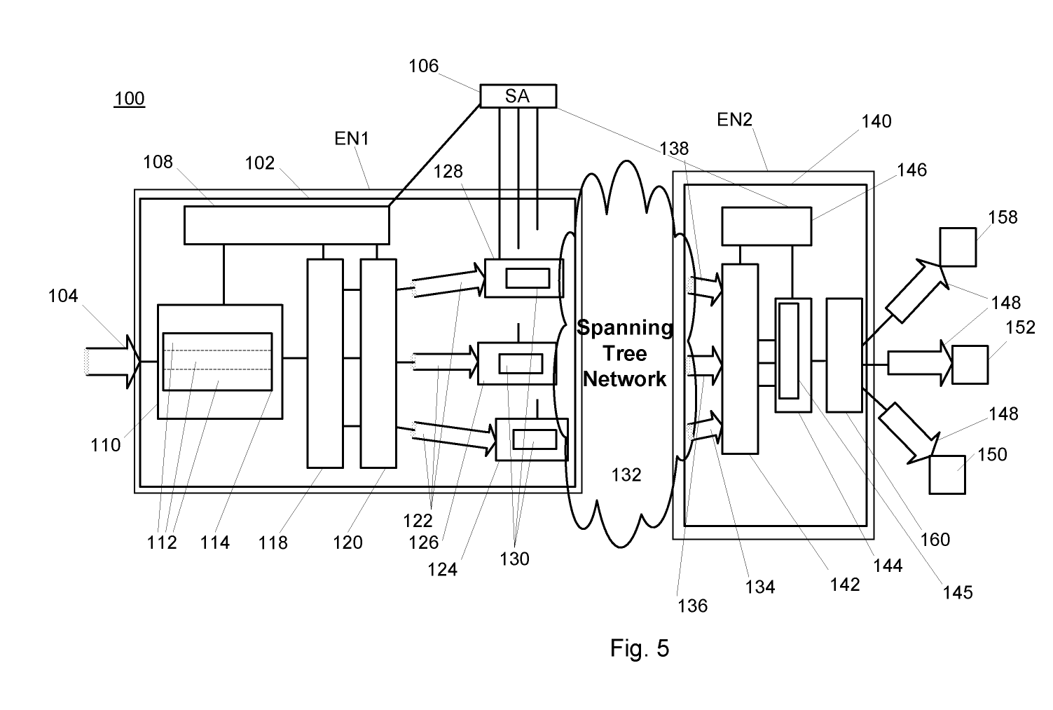

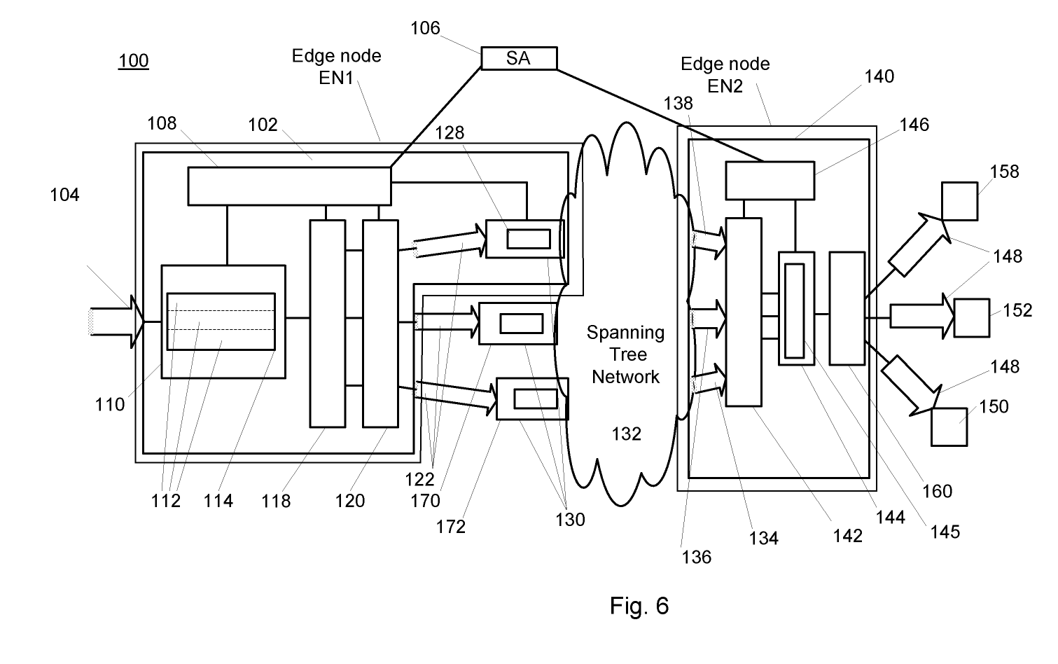

During a multi-cast service deployment, when the multicast stream arrives at the border of this multicast domain NW1, a service agent will split the multicast stream into a number of sub-streams m^{k}, e.g. 3 sub-streams (based on the fact there are 3 trees generated in the example and k=1, 2, 3), and send them separately through 3 different spanning trees. The service agent is an interface at the border of an multicast or a unicast domain. When the three different multicast streams arrive at the end system, they will be grouped together by software in the end system to form the original stream. The receiving end system (140 in FIGS. 5 and 6) may be included in the receiving node, as in EN2 and EN4, or in the receiving user device, as in EN3 and user device 164. When the receiving end system 140 is included in the node, it will deliver a restored multicast stream 148 to the user device/equipment. When the receiving end system 140 is not included in the node, it will deliver the multicast streams 148′, which will be restored to the original multicast stream in the user device/equipment, as shown for EN3 and user device 164.

The present invention is an extension to a robust Ethernet access network architecture and fast failover mechanism are defined, earlier presented in reference [8]. In Ref. [8], several overlay tree-structure networks are configured based on a given physical network topology, each distinct by a VLAN ID. Those tree structures have the following features:
No single link in the network is used by all trees.
No single node in the network is non-leaf node to all trees. Built this way, the overlay networks guarantees there is no single point of failure in the network, which provides a foundation for protection switching and fast fail-over. When it comes to multicast support, this feature makes such a network architecture a good candidate for a novel way of support high-bandwidth multicast transferring. The basic concept can be described as:
   Set up a service agent close to the access network for a given multicast application (such as HDTV), which can be either per service agent, per service provider, or several service providers can share the same service agent.
   For a network that has L spanning trees, the service agent makes the multicast stream into K sub-streams and distributes them evenly or based on certain algorithms (to be discussed) onto the trees.
   Each selected tree transfers the multicast load within its own branches to reach the correct destination group.
   End systems re-assemble the K sub-streams into a complete stream.

Multicast and Unicast streams should be split in an intelligent way, taking use of the codec features. For H.264 and other very modern video codecs a lot of work has been put into splitting the video stream into fault tolerant parts that can recover from packet loss and reordering problems.

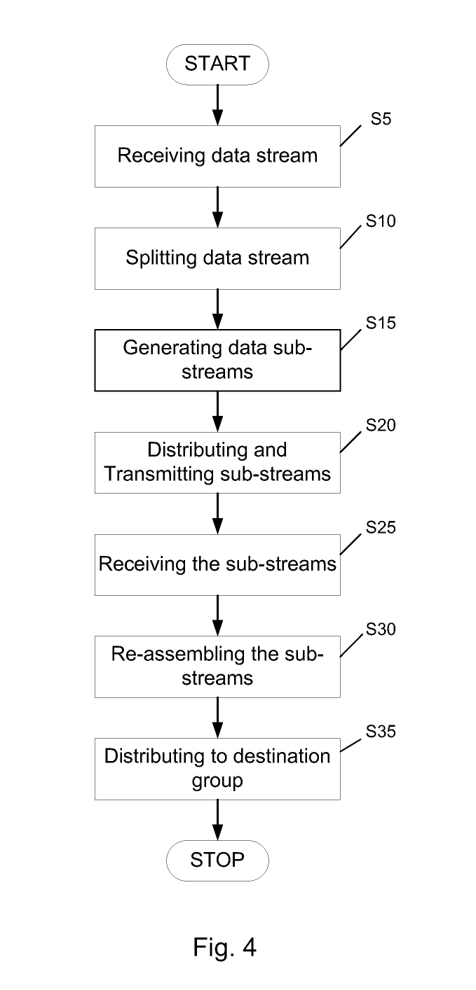

FIG. 4 is a block diagram illustrating a flow-chart of a first embodiment of the invented method of the present invention, step by step.

A source (not shown) feeds a data stream, e.g. a video multicast stream comprising video frames, to a first node on the edge of a spanning tree network, wherein said node comprises a service agent (SA) function for receiving said data stream, step S5. The spanning tree structure network has at least a first and second node, said nodes being edge nodes as they have at least one external connection outside the network. In the next step, step S10, the data information of the incoming data stream (M) is split into a number K of data segments m^{k}(tₚ), wherein each data segment is a unique portion m^{k}(tₚ) of the total amount of data information M(tₚ) carried in the incoming original data stream during time periods tₚ. The incoming multicast stream M is iteratively and continuously split, step S10, into K multicast data sub-streams m^{k} comprising a unique portion m^{k}(tₚ) of the total amount of data information M(tₚ) carried in the incoming original multicast stream during time periods tₚ. Hence, the total data information is divided into pre-determined time periods, and the total data information for each such time period is split and distributed according to a certain scheme or algorithm into different data segments m^{k}(tₚ), which when re-assembled together in time order, time period for time period in correct consecutive order, according to a corresponding reversed algorithm or scheme will constitute the original multicast stream. The flow of data segments for a certain value of K is considered to constitute a sub-stream of the original multicast stream.

In the next step, step S15, a number (K) of data sub-streams m^{k} are generated by distributing said data segments m^{k}(tₚ) to said data sub-streams m^{k}. Thereafter, the different data sub-streams m^{k} are distributed, step S20, to different spanning trees of the network and transmitting each sub-stream through its assigned spanning tree to the second node. All sub-streams m^{k} are received, step S25, in the second node. The data segments m^{k}(tₚ) are re-assembled, step S30, from the received sub-streams m^{k} to regenerate the original data stream M.

Thus, when the different data sub-streams are received at the end system, they will be grouped together by software in the end system to form the original stream. The original stream will be distributed and transmitted, step S35, to the different multicast groups to be used, e.g. viewed by the subscriber if the data information carried by the multicast stream is a television program, movie, etc.

The slices of one multicast stream are simultaneously transmitted as sub-streams and forwarded in different trees through the network, directed to the correct edge node by the switching nodes. In each end system of a receiving node, the sub-streams are correctly reassembled to the original multicast stream. The slices are received and organised by the SA to build up each original video frame of the multicast stream.

FIG. 5 is a block diagram showing a preferred embodiment of a Service Agent System 100 in accordance with the present invention.

FIG. 5 shows a Service Agent System 100 connected to two nodes of a spanning tree network, e.g. a network illustrated in FIG. 3, which network comprises switching nodes. Said network is logically configured into L spanning trees. Further, all edge nodes or at least some of the edge nodes comprise an service agent functionality, which is connected to an access network, e.g. video source, for a given multicast application. The illustrated network that has L spanning trees, but the service agent is capable of dividing the multicast stream into K slices, in this example 3 slices, and distribute them according to a distribution algorithm on K of L spanning trees. Each of the distribution selected trees transfers at least one multicast sub-stream to reach correct edge nodes and destination group. Therefore, said edge nodes of the network are also comprising means for resemble the K slices into a complete multicast stream.

The invented Service Agent method and functionality is enabled by a Service Agent system 100, which now will be described in more details with reference to FIG. 5. Said system comprises at least one transmitting system block 102 and one receiving system block 140. Different nodes will be able to communicate by means of the Service Agent function and means.

A multicast stream 104 is transferred via a suitable connection from at least one source (not shown), e.g. an access network for a given multicast application, to an edge node EN1 on the border of a network domain 132. An edge node controlling unit 108 is arranged to control the different means (of which many is not shown), functions and signal processes of the edge node. The controller 108 is also arranged to handle control communication with external entities by means of a communication interface, which is adapted to handle different application and communication protocols, e.g. receive protocols, read protocols, generate, address and transmit protocols. Further, the edge node comprises a signal processing unit 110 that is arranged to include a lot of different means for performing required and necessary already known signal processing, e.g. encoding, decoding, etc, of incoming data streams, which mostly is received according to a standardized protocol. In accordance with an embodiment of the present invention, a Service Agent function is installed in the edge node EN1 and Service Agent transmitting node means 102 will enable an edge node to perform the Service Agent functionality of the transmitting node.

Different configurations are possible: an edge node may comprise only transmitting system block 102, or only a receiving system block, or both transmitting system block and receiving system block.

Said Service Agent means will be presented in more details in the following description.

According to one embodiment, the Service Agent transmitting node means in block 102 will comprise Service Agent software means adapted to be executed and run by the controller 108 for controlling other Service Agent means. The described communication interface of the controller is adapted to recognize and handle Service Agent control and information communication from external Service agent entities 106, e.g. located in other edge nodes. Further, the Service Agent means comprises slicing means 114 for slicing incoming data streams, buffering means 118 enabling data streams to be temporary stored as data packet slices and distributing means 120 for distributing said slices according to a predetermined distributing algorithm, or distribution scheme, as separated data streams 122.

The multicast stream 104 is fed to slicing means 114 which will slice each frame of the multicast stream 104 into slices 112 according to a selected video codec standard. The slicing means 114 may be a part of the signal processing unit 110 of the edge node.

The generated data streams, 122 are fed to a transmit interface 130 comprising a number of transmitter devices, in this example 124, 126 and 128, for addressing the data packets to at least one distribution group and/or associated edge node EN2 over a number of separate spanning trees (see FIG. 1) of a Spanning Tree Network structure 132. The data packets, or slices, will also be addressed to belong to a certain, selected, spanning tree, by a VLAN Identification, i.e. VLAN ID. Said addresses will be inserted in the header of the data packets. The data packets having identical VLAN ID and edge node address will therefore constitute a multicast sub-stream belonging to a certain spanning tree. As understood by a person skilled in the art, an edge node of the system 100 may be connected to a number of different and identifiable edge nodes in this described embodiment. As a non-limiting example regarding the number of sub-streams in the present embodiment, three separate sub-streams 134, 136 and 138 are illustrated, but a number K of sub-streams may be generated and sent through the network 132, wherein K=0, 1, 2, 3, 4, . . . , N, as discussed in this description

The Service Agent function and means of block 102 of a node EN1 is connected to other Service Agents 106 of other edge nodes to be able to communicate and exchange information, e.g. about the data packet traffic load in different spanning trees, link failure in the tree, etc.

The service agent function can be either one service provider per service agent, or several service providers can share the same service agent.

Further, a Service Agent receiving function is installed in at least one other edge node EN2. Service Agent receiving node means of one Service Agent receiving system block 140 will enable an edge node to perform the Service Agent functionality of the receiving node. Said Service Agent means will be presented in more details in the following description.

As obvious to a person skilled in the art, said receiving node EN2 is an edge node connected to a number of separated spanning trees.

Said Service Agent receiving system block 140 is considered as an end system that comprises a receiving interface 142, controlling unit 146 and a signal processing unit 144 including a receiving block buffer for re-assembling the incoming multicast sub-streams.

The edge node controlling unit 146 corresponds to the controlling unit 108. In the same way, controlling unit 146 is arranged to control the different means (of which many is not shown), functions and signal processes of an edge node. The controller 146 is also arranged to handle control communication with external entities by means of a communication interface, which is adapted to handle different application and communication protocols, e.g. receive protocols, read protocols, generate, address and transmit protocols. The controlling units 108, 146 of the transmitting block 102 and receiving block 140, respectively, will be able to communicate via a control protocol over any of the spanning trees.

Further, the receiving block 140 comprises a signal processing unit 144 that is arranged to include a lot of different means for performing required and necessary already known signal processing, e.g. encoding, decoding, etc, of incoming data streams, which mostly is received according to a standardized protocol. Said signal processing unit 144 includes a Service Agent receiving block buffer for re-assembling the incoming multicast sub-streams, in this example illustrated as three incoming multicast sub-streams. The buffer 145 is arranged to restore the original frames of the original multicast stream 104 by using the header information in the data packets carrying the slices of the original frame.

The node comprises an output interface 160 for transmitting copies of the restored multicast stream 148 to the different user equipments 150, 152, 158 in the destination group connected to the edge node 40.

An alternative embodiment of the present invention is presented in FIG. 6. In the previous embodiment shown in FIG. 5, all multicast sub-streams are entered into the spanning trees connected to one edge node EN2 of the spanning tree network. In the second embodiment, different sub-streams are distributed to and inserted into spanning trees connected to different edge nodes of the network 132. Said edge nodes are provided with a transmitter device 170, 172 and the transmitting interface 130 to enable communication through the network spanning tree links. The two embodiments are similar in other aspects, such as components, blocks, means, functions and operation.

In the multicast streaming case, each frame is divided into K slices in accordance with the used video codec. A slice is defined as a certain region or segment of the frame. A slice is preferably formed as a stripe. In FIG. 5, a frame is sliced in three equally sized horizontal stripes or slices, one upper stripe, one strip in the middle, and one lower stripe. Each slice is then distributed evenly or based on a certain distribution algorithm to all spanning trees or only a selected number of all spanning trees. In other words, the service agent is designed to make the multicast stream into a number K of slices, which the service agent is deigned to distribute on a number K of sub-streams which are distributed through N different edge nodes, each node responsible for a spanning tree, and transmitted onto K spanning trees. If the spanning tree network contains a total sum of L spanning trees, where L≧K, said K spanning trees is selected among all L spanning trees according to certain criteria by the service agent. As stated above, the service agent will distribute different sub-streams to different edge nodes, one stream to one edge node responsible for one multicast tree. An example of a distribution algorithm is Round Robin, which is a well-known algorithm. The algorithm may also consider the spanning tree load to be able to direct slices and/or sub-streams to less loaded spanning trees, or even to un-used spanning trees. The distribution to different spanning trees are possible as each spanning tree has its own unique address, i.e. VLAN ID.

When the data stream is a video multicast stream or unicast stream, a number of typical features should be taken into consideration are among the following (features from the video codec H.264 specification):
Loss resilience features including:
   A Network Abstraction Layer (NAL) definition allowing the same video syntax to be used in many network environments, including features such as Sequence Parameter Sets (SPSs) and Picture Parameter Sets (PPSs) that provide more robustness and flexibility than provided in prior designs;
   Flexible Macroblock Ordering (FMO, also known as slice groups and not supported in all profiles) and arbitrary slice ordering (ASO), which are techniques for restructuring the ordering of the representation of the fundamental regions (called macroblocks) in pictures. Typically considered an error/loss robustness feature, FMO and ASO can also be used for other purposes;
   Data partitioning (DP), a feature providing the ability to separate more important and less important syntax elements into different packets of data, enabling the application of unequal error protection (UEP) and other types of improvement of error/loss robustness (not supported in all profiles);
   Redundant slices (RS), an error/loss robustness feature allowing an encoder to send an extra representation of a picture region (typically at lower fidelity) that can be used if the primary representation is corrupted or lost (not supported in all profiles);
   Frame numbering, a feature that allows the creation of “sub-sequences” (enabling temporal scalability by optional inclusion of extra pictures between other pictures), and the detection and concealment of losses of entire pictures (which can occur due to network packet losses or channel errors).
Switching slices (called SP and SI slices and not supported in all profiles), features that allow an encoder to direct a decoder to jump into an ongoing video stream for such purposes as video streaming bit rate switching and “trick mode” operation. When a decoder jumps into the middle of a video stream using the SP/SI feature, it can get an exact match to the decoded pictures at that location in the video stream despite using different pictures (or no pictures at all) as references prior to the switch;
A simple automatic process for preventing the accidental emulation of start codes, which are special sequences of bits in the coded data that allow random access into the bitstream and recovery of byte alignment in systems that can lose byte synchronization.

Mixed scenarios where the some channels are split over different paths and others are transmitted in a classical way works too.

If there is a node or link failure in the network, the edge node that detects the failure based on mechanism in [9] will send an alarm to the service agent functions, with information about which tree is temporarily unavailable, reacting upon a failure, the service agent function can either re-split the multicast stream, or simply merge the segment originally transferred through the now-unavailable tree into another segment, and continue the transmission until the failure is fixed and the affecting tree recovered. In the example discussed with reference to FIG. 3, suppose link Lg between SW1 and SW2 is down, causing tree ST1 to break, the service agent will either re-split the multicast stream into only two sub-streams, namely S2 and S3, or it can merge the sub-streams S1 with S2 or S3, and then continue transmitting the two sub-streams on ST2 and ST3.

With the help of [10], the failure can be located and fixed with high efficiency.

When the present invented technique is used, a network failure can be planned for in advance, so the maximum use of codec capabilities can be used. A network failure will result in a more codec friendly packet loss, so minimal quality loss is achieved. In many cases, packet losses of this kind can be recovered without any visible artifacts at all.

The present invention is a hybrid of a centralized solution and totally distributed peer-to-peer solution. It uses the load distribution idea of the peer-to-peer world. By splitting the multicast stream into a number of segments and transferring them through different trees, it overcomes the unbalanced resource usage faced by traditional single tree multicasting, thus improves the bandwidth efficiency of the network system and performance of the multicast application. In other words, it introduces the high resource efficiency of a peer-to-peer system into a network provider domain. On the other hand, by introducing the concept of service agent, it does not rely on end systems to participate actively into the multicast splitting process as peer-to-peer systems do, which in turn gives operators a better control over the network and traffic running in it.

The invention may be implemented in digital electronically circuitry, or in computer hardware, firmware, software, or in combinations of them. Apparatus of the invention may be implemented in a computer program product tangibly embodied in a machine readable storage device for execution by a programmable processor; and method steps of the invention may be performed by a programmable processor executing a program of instructions to perform functions of the invention by operating on input data and generating output.

The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such internal hard disks and removable disks; magneto-optical disks; and CD-ROM disks. Any of the foregoing may be supplemented by, or incorporated in, specially-designed ASICs (Application Specific Integrated Circuits).

A number of embodiments of the present invention have been described. It will be understood that various modifications may be made without departing from the scope of the invention. Therefore, other implementations are within the scope of the following claims defining the invention.

### REFERENCE LIST

[1] M. Castro, P. Druschel, et al Split Stream: High-bandwidth content distribution in cooperative environments. In Proc of the 19^{th} ACM SOSP, October 2003
[2] Request for Comments RFC 3376, Internet group management protocol version 3
[3] Request for Comments RFC 2710, Multicast Listener Discovery (MLD) for IPv6
[4] Request for Comments RFC 1075, Distance Vector Multicast Routing Protocol.
[5] Request for Comments RFC 1584, Multicast Extension to OSPF
[6] Request for Comments RFC 2362, Protocol Independent Multicast Sparse Mode (PIM-SM)
[7] C. Diot, B. N. Levine, et al “Deployment issues for the IP Multicast Service and Architecture”, In IEEE networks special issue on multicast, 2000.
[8] WO2006/135282 A1: J. Farkas, C. Antal and L. Westberg, “Method and arrangement for failure handling in a network,” Patent application, filed: 14 Jun., 2005.
[9] WO2007/043919 A1: J. Farkas, G. Tóth, “Method of generating spanning trees,” Patent application, filed: 11 Oct., 2005.
[10] PCT/EP2007/051219: J. Farkas, Wei Zhao, “Method for Fault Localisation in Multiple Spanning Tree Based Architectures”, 8 Feb., 2007.

1. A method for transmitting a data stream from a first node of a spanning tree structure network to a second node of said network, said nodes having at least one external connection outside the network, said method comprising following steps:
Splitting data information of the incoming data stream (M) into a number (K) of data segments (m^{k}(tₚ)), wherein each data segment is a unique portion m^{k}(tₚ) of the total amount of data information M(tₚ) carried in the incoming original data stream during time periods tₚ (S10);
Generating a number (K) of data sub-streams (m^{k}) by distributing said data segments (m^{k}(tₚ)) to said data sub-streams (m^{k}) (S15);
Distributing the different data sub-streams (m^{k}) to different spanning trees of the network and transmitting each sub-stream through its assigned spanning tree to the second node (S20);
Receiving all sub-streams (m^{k}) in the second node (S25);
Re-assembling the data segments (m^{k}(tₚ)) from the received sub-streams (m^{k}) to regenerate the original data stream (M) (S30).

2. The method according to claim 1, wherein the step of distributing the different data sub-streams (m^{k}) to different spanning trees of the network involves a distribution algorithm or a distribution scheme.

3. The method according to claim 2, wherein the distribution scheme is a Round Robin distribution process.

4. The method according to claim 2, wherein the distribution algorithm consider the data traffic load in the spanning trees and nodes of the network.

5. The method according to any of claims 1-4, wherein the data stream is either a multicast stream or a unicast stream.

6. The method according to claim 5, wherein the data information of the data stream is belonging to separate video frames.

7. The method according to claim 6, wherein the step of splitting data information of the incoming data stream (M) involves a slicing process of the data information of each video frame into a number (K) of data slices (m^{k}(tₚ)), wherein the slices will be distributed on the data sub-streams.

8. The method according to claim 7, wherein the slicing of the video frames are controlled according to a video codec standard.

9. The method according to any of the preceding claims, wherein the first and second nodes are edge nodes of the network.

10. The method according to claim 9, wherein the step of distributing the different data sub-streams (m^{k}) to different spanning trees of the network and transmitting each sub-stream through its assigned spanning tree to the second node, all sub-streams originating from the incoming data stream are fed to and transmitted from only said first node to which said spanning trees are connected.

11. The method according to claim 9, wherein the step of distributing the different data sub-streams (m^{k}) to different spanning trees of the network and transmitting each sub-stream through its assigned spanning tree to the second node, at least one of the sub-streams originating from the incoming data stream are distributed to another edge node than the first node, as the assigned spanning tree for transmitting said at least one sub-stream are connected to said other node.

12. A Service Agent (SA) system for transmitting a data stream from a first node of a spanning tree structure network to a second node of said network, said nodes having at least one external connection outside the network, wherein the system comprises a transmitting system block (102) situated in the first node, the block comprising splitting means (110) for splitting data information of the incoming data stream (M) into a number (K) of data segments (m^{k}(tₚ)), wherein each data segment is a unique portion m^{k}(tₚ) of the total amount of data information M(tₚ) carried in the incoming original data stream during time periods tₚ, the block further comprises means (118) for generating a number (K) of data sub-streams (m^{k}) by distributing said data segments (m^{k}(tₚ)) to said data sub-streams (m^{k}), wherein the means for generating data sub-streams is electrically connected to means (120) for distributing the different data sub-streams (m^{k}) to different spanning trees of the network, said means (120) being connected to a transmitter interface (124,126,128) to transmit each sub-stream through its assigned spanning tree to a receiving system block 140 situated in the second node and comprising receiving means (142) for receiving all incoming data sub-streams (m^{k}), and for forwarding said sub-streams to means (144) for re-assembling the data segments (m^{k}(tₚ)) from the received sub-streams (m^{k}) to regenerate the original data stream (M).

13. The system according to claim 12, wherein the means (120) for distributing the different data sub-streams (m^{k}) to different spanning trees of the network involves a distribution algorithm or a distribution scheme.

14. The system according to claim 13, wherein the distribution scheme is a Round Robin distribution process.

15. The system according to claim 14, wherein the distribution algorithm consider the data traffic load in the spanning trees and nodes of the network.

16. The system according to any of claims 12-15, wherein the data stream is either a multicast stream or a unicast stream.

17. The system according to claim 16, wherein the data information of the data stream is belonging to separate video frames.

18. The system according to claim 17, wherein the splitting means (110) for splitting data information of the incoming data stream (M) is a slicing means for slicing the data information of each video frame into a number (K) of data slices (m^{k}(tₚ)), wherein the slices will be distributed on the data sub-streams.

19. The system according to claim 18, wherein the slicing of the video frames are controlled according to a video codec standard.

20. The system according to any of claims 12-19, wherein the first and second nodes are edge nodes of the network.

21. The system according to claim 20, wherein, all sub-streams originating from the incoming data stream are fed to and transmitted from only said first node to which said spanning trees are connected.

22. The system according to claim 20, wherein at least one of the sub-streams originating from the incoming data stream are distributed to another edge node than the first node, as the assigned spanning tree for transmitting said at least one sub-stream are connected to said other node.

23. A transmitting device (102) for transmitting a data stream from a first node of a spanning tree structure network to a second node of said network, said nodes having at least one external connection outside the network, wherein the device (102) comprises splitting means (110) for splitting data information of the incoming data stream (M) into a number (K) of data segments (m^{k}(tₚ)), wherein each data segment is a unique portion m^{k}(tₚ) of the total amount of data information M(tₚ) carried in the incoming original data stream during time periods tₚ, the block further comprises means (118) for generating a number (K) of data sub-streams (m^{k}) by distributing said data segments (m^{k}(tₚ)) to said data sub-streams (m^{k}), wherein the means for generating data sub-streams is electrically connected to means (120) for distributing the different data sub-streams (m^{k}) to different spanning trees of the network, said means (120) being connected to a transmitter interface (124,126,128) to transmit each sub-stream through its assigned spanning tree to the second node.

24. The device according to any of claim 23, wherein the data stream is either a multicast stream or a unicast stream.

25. The device according to claim 24, wherein the data information of the data stream is belonging to separate video frames.

26. The device according to claim 25, wherein the splitting means (110) for splitting data information of the incoming data stream (M) is a slicing means for slicing the data information of each video frame into a number (K) of data slices (m^{k}(tₚ)), wherein the slices will be distributed on the data sub-streams.

27. The device according to claim 26, wherein the slicing of the video frames are controlled according to a video codec standard.

28. The device according to any of claims 23-27, wherein the first and second nodes are edge nodes of the network.

29. The device according to claim 23, wherein, all sub-streams originating from the incoming data stream are fed to and transmitted from only said first node to which said spanning trees are connected.

30. The device according to claim 23, wherein at least one of the sub-streams originating from the incoming data stream are distributed to another edge node than the first node, as the assigned spanning tree for transmitting said at least one sub-stream are connected to said other node.

31. A receiving device (140) for receiving a data stream transmitted from a first node of a spanning tree structure network, the nodes having at least one external connection outside the network, wherein the device (140) comprises receiving means (142) for receiving all incoming data sub-streams (m^{k}), and for forwarding said sub-streams to means (144) for re-assembling data segments (m^{k}(tₚ)) from the received sub-streams (m^{k}) to regenerate an original data stream (M), which was splitted in the first node into a number (K) of data segments (m^{k}(tₚ)), wherein each data segment is a unique portion m^{k}(tₚ) of the total amount of data information M(tₚ) carried in the incoming original data stream during time periods tₚ, and wherein the number (K) of data sub-streams (m^{k}) was generated by distributing said data segments (m^{k}(tₚ)) to the data sub-streams (m^{k}).

32. A receiving device (140) according to claim 31, wherein the device comprises an output interface (160) for transmitting the restored multicast stream (M) to different user equipments (150, 152, 154) in the destination group connected to the second node.

33. The receiving device according to any of claims 31-32, wherein the first and second nodes are edge nodes of the network.
